(19) United States
(12) Patent Application Publication
(10) Pub. No.: US 2026/0058467 A1
(43) Pub. Date: Feb. 26, 2026

(54) POWER MANAGEMENT SYSTEM AND METHOD

(71) Applicants: LITE-ON SINGAPORE PTE. LTD., Singapore (SG); LITE-ON TECHNOLOGY CORPORATION, TAIPEI CITY (TW)

(72) Inventors: En Cheng Benjin LAU, Singapore (SG); Jeynil David CRISOSTOMO, Singapore (SG); Meng-Rong LEE, TAIPEI CITY (TW)

(21) Appl. No.: 19/090,596

(22) Filed: Mar. 26, 2025

Related U.S. Application Data
(60) Provisional application No. 63/685,799, filed on Aug. 22, 2024.
(60) Provisional application No. 63/717,954, filed on Nov. 8, 2024.

(51) Int. Cl. H02J 3/00; H02J 3/32; H02J 3/38; H02J 7/35

(52) U.S. Cl. CPC H02J 3/0075; H02J 3/003; H02J 3/004; H02J 3/32; H02J 3/38; H02J 7/35; H02J 2203/20; H02J 2300/24; H02J 2310/12

(57) ABSTRACT

A power management system is provided, which is electrically coupled to a photovoltaic array, a power grid, and a battery, and includes a power converter, and a processing module. The power converter is configured to operate in one of operation modes, including a self-consumption mode, a Time of Use mode, and a backup mode, to regulate power flow among the photovoltaic array, the power grid, and the battery. The processing module is configured to generate, through a forecast model, predicted data representing power demand, power generation of the photovoltaic array, and tariff of the power grid over a first time period; determine one of the operation modes to be a target mode for the power converter and a corresponding switch time based on the time series of predicted data; and control the power converter to operate in the target mode at the switch time.

### CROSS REFERENCE TO RELATED APPLICATIONS

This application claims the benefit of U.S. Provisional Application No. 63/685,799, filed Aug. 22, 2024, and U.S. Provisional Application No. 63/717,954, filed Nov. 8, 2024, the entirety of which is/are incorporated by reference herein.

### BACKGROUND OF THE INVENTION

### Field of the Invention

The present invention relates to power management, and, in particular, to power management using Artificial Intelligence (AI) technology.

### Description of the Related Art

Power management refers to the process of efficiently generating, distributing, storing, and consuming electricity to ensure a stable and reliable power supply. It involves monitoring energy flow, optimizing efficiency, and balancing supply and demand to prevent waste and reduce costs. Three critical components in modern power management are photovoltaic (PV) arrays, power grids, and batteries. PV arrays generate electricity from sunlight, power grids distribute and regulate electricity across large networks, and batteries store excess energy for later use. Together, these elements work to enhance energy sustainability, grid stability, and resilience in various applications.

In an existing power management system, three common modes are provided, including self-consumption mode, Time of Use (TOU) mode, and backup mode. These modes help maximize energy efficiency, reduce costs, and improve reliability by leveraging PV arrays, power grids, and batteries in different ways.

In self-consumption mode, the system prioritizes using the electricity generated by the PV array for the load before drawing power from the grid and the battery. In TOU mode, the facts that electricity prices are higher during peak hours and lower during off-peak hours are considered. Therefore, during the peak hours, the system prioritizes using the electricity generated by the PV array and the battery during the peak hours for the load. During the off-peak hours, the system prioritizes using the electricity generated by the PV array for the load and for charging the battery. In backup mode, the system prioritizes charging the battery.

However, without sufficient knowledge, it is quite difficult for a common user to select an appropriate mode to optimize power usage. Users may struggle to analyze factors such as electricity pricing trends, solar energy availability, and battery state of charge (SOC) in real time. Additionally, manually switching between modes requires continuous monitoring and decision-making, which can be inconvenient and inefficient. As a result, improper mode selection may lead to suboptimal energy utilization, increased costs, and reduced system efficiency.

Therefore, a power management system and method that can solve the above problems are needed.

### BRIEF SUMMARY OF THE INVENTION

An embodiment of the present invention provides a power management system for a building. The power management system is electrically coupled to a photovoltaic (PV) array, a power grid, and a battery. The power management system includes a power converter and a processing module. The power converter is configured to operate in one of operation modes to regulate power flow among the PV array, the power grid, and the battery, wherein the operation modes include a self-consumption mode, a Time of Use (TOU) mode, and a backup mode. The processing module is configured to generate, through a forecast model, predicted data representing power demand of the building, power generation of the PV array, and tariff of the power grid over a first time period; determine one of the operation modes to be a target mode for the power converter and a corresponding switch time based on the time series of predicted data; and control the power converter to operate in the target mode at the switch time.

In one embodiment, the power converter is configured to, in the self-consumption mode, prioritize using the power generation of the PV array and the battery to supply the power demand of the building; in the TOU mode, prioritize using the power generation of the PV array and the battery to supply the power demand of the building during peak hours, and prioritize using the power generation of the power grid to supply the power demand of the building during off-peak hours; and in the backup mode, prioritize using the power generation of the PV array to charge the battery.

In one embodiment, the processing module is further configured to, in response to the power converter operating in the self-consumption mode, determine the target mode to be the backup mode if the predicted data representing the tariff of the power gird indicates that the tariff will decrease and the predicted data representing the power demand of the building indicates that the power demand will decrease; in response to the power converter operating in the backup mode, determine the target mode to be the self-consumption mode if the predicted data representing the tariff of the power gird indicates that the tariff will increase, the predicted data representing the power generation of the PV array indicates that the power generation of the PV array will decrease, and the power demand of the building indicates that the power demand will increase; and in response to the power converter operating in the TOU mode, determine the target mode to be the self-consumption mode if the predicted data representing the tariff of the power gird indicates that the tariff will increase, the predicted data representing the power generation of the PV array indicates that the power generation of the PV array will increase, and the power demand of the building indicates that the power demand will decrease.

In one embodiment, the processing module is further configured to record data representing the power demand of the building, the power generation of the PV array, and the tariff of the power grid over a second time period, wherein the second time period is within the first time period and is after the target mode has been determined and before the switch time has been reached; compare the predicted data within the second time period and the recorded data; and in response to the predicted data within the second time period matching the recorded data, control the power converter to operate in the target mode at the switch time.

In one embodiment, the processing module is further configured to, in response to the predicted data within the second time period not matching the recorded data, switch the power converter from the self-consumption mode to the TOU mode if the power demand of the building does not decrease; switch the power converter from the backup mode to the TOU mode if the power generation of the PV array decreases; switch the power converter from the TOU mode to the self-consumption mode if a State of Charge (SOC) of the battery is higher than a charging threshold.

In one embodiment, the processing module is further configured to, in response to the predicted data within the second time period not matching the recorded data, maintain the operation mode where the power converter is currently operating; and repeat, until the predicted data within the second time period matches the recorded data, the operation of recording the data representing the power demand of the building, the power generation of the PV array, and the tariff of the power grid over the second time period and the operation of comparing the predicted data within the second time period and the recorded data.

In one embodiment, the processing circuitry is further configured to generate, through the forecast model based on historical data representing the power demand of the building and the power generation of the PV array from a past period, the predicted data in a time resolution equal to or smaller than the second time period, wherein the length of the past period is longer than the first time period In one embodiment, the forecast model is trained using at least one of a weather dataset, a home appliance dataset, a PV generation dataset, and a power demand dataset.

In one embodiment, the processing module is further configured to, before determining the target mode check whether the tariff of the power grid, a State of Charge (SOC) of the battery, and the power generation of the PV array meet a criterion corresponding to the operation mode where the power converter is currently operating; and in response to meeting the corresponding criterion, maintain the operation mode where the power converter is currently operating.

In one embodiment, the criterion includes, for the self-consumption mode, requiring the tariff and the SOC of the battery to be over a maximum tariff threshold and a maximum battery threshold respectively; for the TOU mode, requiring the tariff and the power generation of the PV array to be below a minimum tariff threshold and a minimum PV threshold respectively; and for the backup mode, requiring the tariff to be below the minimum tariff threshold and the SOC of the battery to be over the maximum battery threshold.

An embodiment of the present invention provides a power management method. The power management method is executed by a system for a building. The system includes a power converter and a processing module and is electrically coupled to a photovoltaic (PV) array, a power grid, and a battery. The power management method includes, by the power converter, operating in one of operation modes to regulate power flow among the PV array, the power grid, and the battery, wherein the operation modes include a self-consumption mode, a Time of Use (TOU) mode, and a backup mode. The power management method further includes, by the processing module, generating, through a forecast model, predicted data representing power demand of the building, power generation of the PV array, and tariff of the power grid over a first time period; determining one of the operation modes to be a target mode for the power converter and a corresponding switch time based on the time series of predicted data; and controlling the power converter to operate in the target mode at the switch time.

The power management system provided herein automatically determines an operation mode for the power converter to regulate power flow among the PV array, the power grid, and the battery. More specifically, by applying AI technology, the power management system can flexibly and accurately switch the power converter between different operation mode in various scenarios based on past, current and future data. This maximizes energy efficiency, reduces costs, and improves reliability.

### BRIEF DESCRIPTION OF THE DRAWINGS

The present invention can be more fully understood by reading the subsequent detailed description and examples with references made to the accompanying drawings, wherein:

FIG. 1 shows a system architecture diagram of a power management system, according to an embodiment of the present disclosure;

FIG. 2 shows a flow diagram of a power management method executed by the processing module, according to an embodiment of the present disclosure;

FIG. 3 is a schematic diagram illustrating the step of determining a target mode and switch time, according to an embodiment of the present disclosure;

FIG. 4 is a flow diagram illustrating an implementation of the step of controlling the power converter to operate in the target mode at the switch time, according to an embodiment of the present disclosure;

FIG. 5 is a schematic diagram illustrating a step executed after the step of comparing the predicted data and the recorded data if the predicted data does not match the recorded data, according to an embodiment of the present disclosure; and

FIG. 6 is a schematic diagram illustrating a step executed before the step of determining a target mode and switch time, according to an embodiment of the present disclosure.

### DETAILED DESCRIPTION OF THE INVENTION

The following description is made for the purpose of illustrating the general principles of the disclosure and should not be taken in a limiting sense. The scope of the disclosure is best determined by reference to the appended claims.

In each of the below embodiments, the same or similar elements or components will be represented by the same reference numerals.

The serial numbers in this description and the scope of the patent application, such as “first”, “second”, etc., are only for convenience of explanation, and there is no sequential relationship between them.

The description of the embodiments of the device or system in this disclosure also applies to the embodiments of the method, and vice versa.

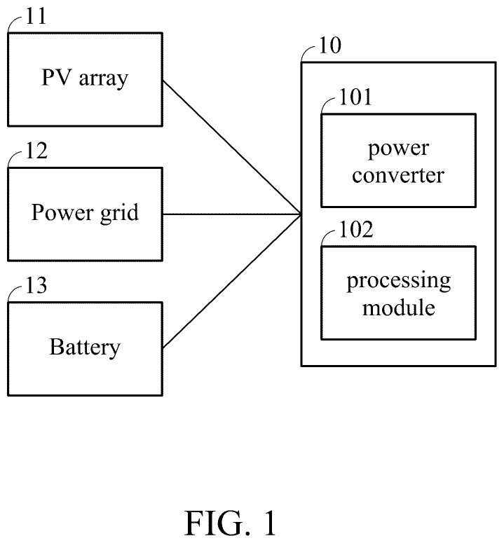

FIG. 1 shows a system architecture diagram of a power management system 10, according to an embodiment of the present disclosure. The power management system 10 may be installed in a building. As shown in FIG. 1, the power management system 10 includes a power converter 101 and a processing module 102, and is electrically coupled to a photovoltaic (PV) array 11, a power grid 12, and a battery 13.

The power management system 10 can be implemented using any computer system with computing capabilities, such as a microcontroller, a personal computer (e.g., a desktop computer or a notebook computer), a server computer or a mobile device (e.g., a tablet computer or smart phone). It can also be implemented using a computer cluster composed of multiple computers collaborating, but the present disclosure is not limited thereto.

The power converter 101 can be implemented using any computer with computing capabilities, such as a microcontroller, a personal computer (e.g., a desktop computer or a notebook computer), a server computer, or a mobile device (e.g., a tablet computer or smart phone). Alternatively, the power converter 101 can be implemented using an integrated circuit, e.g., Application-Specific Integrated Circuit (ASIC), System on a Chip (SoC), or field-programmable gate array (FPGA), but the present disclosure is not limited thereto.

The processing module 102 may include any one or more general-purpose or special-purpose processors and combinations thereof for executing instructions, e.g., a central processing unit (CPU) and/or a graphics processing unit (GPU). The processing module 102 may also include volatile memories such as dynamic random access memory (DRAM) and/or static random access memory (SRAM), but the present disclosure is not limited thereto.

In one embodiment, the power converter 101 may operate in one of operation modes, so as to regulate power flow among the PV array 11, the power grid 12, and the battery 13. For example, the power converter 101 may designate the PV array 11 and the battery 13 as the power sources. For another example, the power converter 101 may solely designate the power grid 12 as the power source.

In one embodiment, the operation modes may include a self-consumption mode, a Time of Use (TOU) mode, and a backup mode.

In the self-consumption mode, the power converter 101 may prioritize using the power generation of the PV array 11 and the battery 13 to supply the power demand of the building. In one embodiment, the power converter 101 may further utilize the power generation of the PV array 11 to charge the battery 13 if the power generation of the PV array 11 exceeds the power demand. In one embodiment, the power converter 101 may further utilize the power generation of the power grid 12 or the battery 13 to supply the power demand if the power generation of the PV array 11 is insufficient to meet the power demand.

In the TOU mode, during peak hours, the power converter 101 may prioritize using the power generation of the PV array 11 and the battery 13 to supply the power demand of the building. Moreover, during off-peak hours, the power converter 101 may prioritize using the power generation of the power grid 12 to supply the power demand of the building. In one embodiment, the power converter 101 may further utilize the power generation of the power grid 12 to charge the battery 13 during the off-peak hours.

In another embodiment of the TOU mode, during off-peak hours, the power converter 101 may prioritize using the power generation of the PV array 11 to supply the power demand of the building and to charge the battery 13. The power converter 101 may further utilize the power generation of the power grid 12 if the power generation of the PV array 11 is insufficient to meet the power demand.

In the backup mode, the power converter 101 may prioritize using the power generation of the PV array 11 to charge the battery 13. Additionally, if the power generation from the PV array 11 is insufficient, the power converter 101 may draw electricity from the power grid 12 to ensure that the battery 13 reaches a predefined state of charge, thereby maintaining backup power availability.

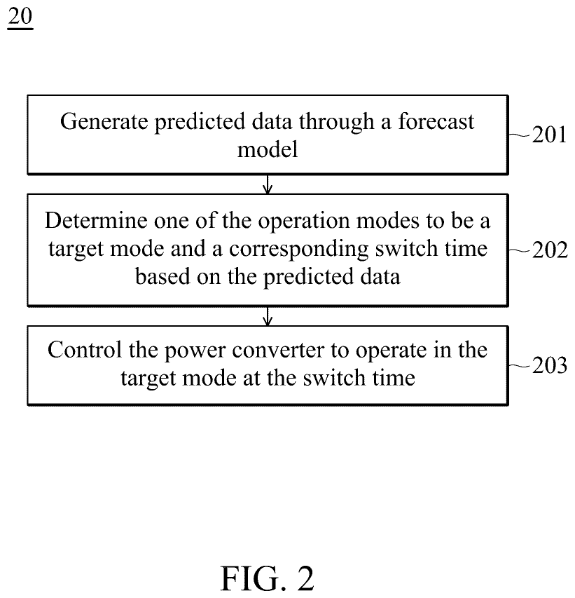

FIG. 2 shows a flow diagram of a power management method 20 executed by the processing module 102, according to an embodiment of the present disclosure. As shown in FIG. 2, the power management method 20 includes steps 201-203.

In step 201, the processing module 102 may generate predicted data representing power demand of the building, power generation of the PV array, and tariff of the power grid through a forecast model over a first time period (e.g., within the next 3 hours, 6 hours, or 12 hours).

In one embodiment, the processing module 102 generates the predicted data through the forecast model based on historical data representing the power demand of the building and the power generation of the PV array, and tariff of the power grid from a past period. The length of the past period is longer than the first time period. The forecast model is trained using the historical data to learn patterns and correlations among power demand, PV generation, and grid tariffs, enabling it to generate accurate predictions for future periods, such as the aforementioned first time period.

In one embodiment, the processing module 102 generates the predicted data through the forecast model not only based on the historical data but also based on external variables, including but not limited to the probability of precipitation, temperature, humidity, and/or power consumption of household appliances.

In one embodiment, the forecast model may be implemented using a time series model, which leverages the temporal dependencies and inherent patterns in historical data to predict future values. For example, the forecast model may be implemented using Autoregressive Integrated Moving Average (ARIMA), Seasonal ARIMA (SARIMA), Long Short-Term Memory (LSTM), or Holt-Winters model, but the present disclosure is not limited thereto.

In one embodiment, the forecast model may be implemented using a regression model, such as Decision Tree Regression, Random Forest Regression, eXtreme Gradient Boosting (XGboost), or Neural Networks (NN), but the present disclosure is not limited thereto.

In one embodiment, the forecast model is trained using a weather dataset, a home appliance dataset, a PV generation dataset, or a power demand dataset. The weather dataset refers to environmental data such as probability of precipitation, temperature, humidity temperature, and/or humidity. The home appliance dataset refers to appliance data such as compressor speed and fan speed of an air conditioner. Depending on the algorithm of the forecast model, the forecast model may perform supervised or unsupervised learning on theses training datasets.

In step 202, the processing module 102 may determine, based on the predicted data, an operation mode to be a target mode for the power converter 101 and a corresponding switch time. The determination may consider factors such as forecasted electricity prices, expected solar power generation, and the battery's state of charge to optimize energy usage. In step 203, the processing module 102 may control the power converter 101 to operate in the target mode at the switch time, ensuring efficient power management and minimizing energy costs.

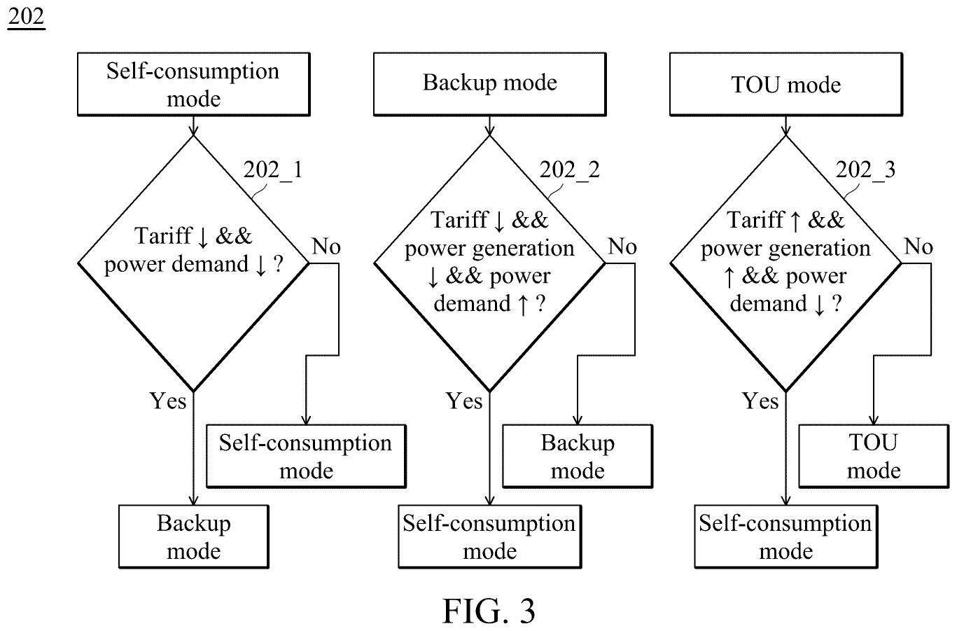

FIG. 3 is a schematic diagram illustrating step 202 in FIG. 2, according to an embodiment of the present disclosure. As shown in FIG. 3, step 202 may further involve the use of criteria 202_1-202_3.

In one embodiment, the criterion 202_1 may correspond to the self-consumption mode. It may require that the predicted data representing the tariff of the power gird indicates that the tariff will decrease, and the predicted data representing the power demand of the building indicates that the power demand will decrease. If the criterion 202_1 is met, the processing module 102 may determine the target mode to be the backup mode for the power converter 101 that is operating in the self-consumption mode. If the criterion 202_1 is not met, the processing module 102 may determine the target mode to be the self-consumption mode for the power converter 101 that is operating in the self-consumption mode.

In one embodiment, the criterion 202_2 may correspond to the backup mode. It may require that the predicted data representing the tariff of the power gird indicates that the tariff will increase, the predicted data representing the power generation of the PV array indicates that the power generation of the PV array will decrease, and the power demand of the building indicates that the power demand will increase. If the criterion 202_2 is met, the processing module 102 may determine the target mode to be the self-consumption mode for the power converter 101 that is operating in the backup mode. If the criterion 202_2 is not met, the processing module 102 may determine the target mode to be the backup mode for the power converter 101 that is operating in the backup mode.

In one embodiment, the criterion 202_3 may correspond to TOU mode. It may require that the predicted data representing the tariff of the power gird indicates that the tariff will increase, the predicted data representing the power generation of the PV array indicates that the power generation of the PV array will increase and the power demand of the building indicates that the power demand will decrease. If the criterion 202_3 is met, the processing module 102 may determine the target mode to be the self-consumption mode for the power converter 101 that is operating in the TOU mode. If the criterion 202_3 is not met, the processing module 102 may determine the target mode to be the TOU mode for the power converter 101 that is operating in the TOU mode.

In one implementation, the trend of the predicted data may be observed using various mathematical and algorithmic techniques, such as Rate of Change (ROC) calculation, Moving Average (MA), Regression Analysis or Time Series Analysis (e.g., time series models ARIMA), but the disclosure is not limited thereto.

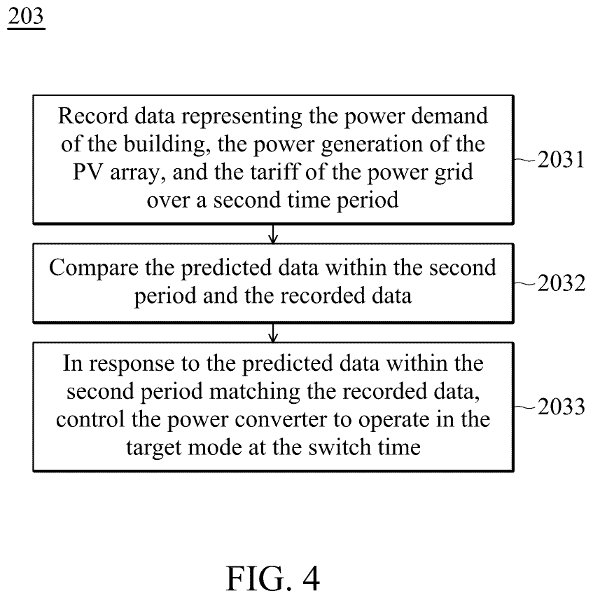

FIG. 4 is a flow diagram illustrating the step 203 in FIG. 2, according to an embodiment of the present disclosure. As shown in FIG. 4, step 203 further includes steps 2031˜2033.

In step 2031, the processing module 102 may record data representing the power demand of the building, the power generation of the PV array, and the tariff of the power grid over a second time period. The second time period is within the first time period and is after the target mode has been determined and before the switch time has been reached.

In step 2032, the processing module 102 may compare the predicted data within the second time period and the recorded data, so as to check whether its prediction is accurate.

In step 2033, if the predicted data within the second time period matches the recorded data, the processing module 102 may control the power converter 101 to operate in the target mode at the switch time. If the predicted data matches the recorded data, it indicates that the prediction of the processing module 102 is accurate. Therefore, the processing module 102 does not need to re-determine the target mode, and may control the power converter 101 to operate in the previously-determined target mode at the previously-determined switch time.

On the contrary, if the predicted data does not match the recorded data, it indicates that the prediction of the processing module 102 is inaccurate. Therefore, the processing module 102 needs to re-determine the target mode.

In one embodiment, if the predicted data within the second time period does not match the recorded data, the processing module 102 may maintain the operation mode where the power converter is currently operating, and may repeat steps 2031 and 2032 until the predicted data within the second period matches the recorded data. Once the predicted data matches the recorded data, the processing module 102 executes steps 2033 to control the power converter 101 to operate in the target mode.

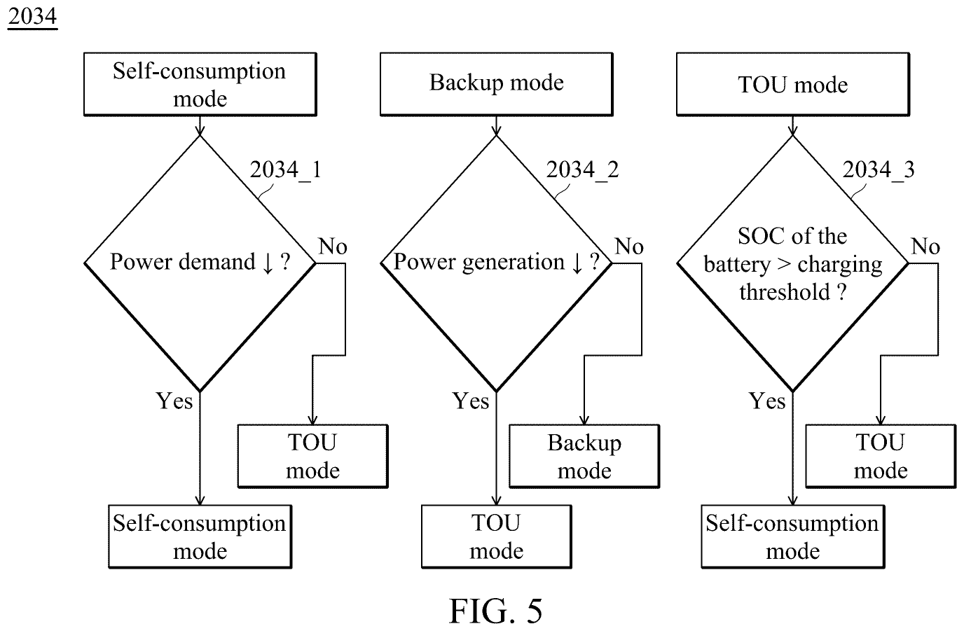

FIG. 5 is a schematic diagram illustrating step 2034, according to an embodiment of the present disclosure. Step 2034 is executed after step 2032 if the predicted data does not match the recorded data. As shown in FIG. 5, step 2034 may further involve the use of criteria 2034_1-2034_3.

In one embodiment, the criterion 2034_1 may correspond to the self-consumption mode. It may require the power demand of the building decreases. If the criteria 2034_1 is not met, the processing module 102 may switch the power converter from the self-consumption mode to the TOU mode. If the criteria 2034_1 is met, the processing module 102 may maintain the power converter 101 operating in the self-consumption mode. Specifically, the processing module 102 may re-determine the target mode to be the TOU mode for the power converter 101 that is operating in the self-consumption mode. Then, the processing module 102 may control the power converter 101 to operate in the TOU mode immediately instead of waiting until the switch time.

In one embodiment, the criterion 2034_2 may correspond to the backup mode. It may require the power generation of the PV array decreases. If the criteria 2034_2 is met, the processing module 102 may switch the power converter from the backup mode to the TOU mode. If the criteria 2034_2 is not met, the processing module 102 may maintain the power converter 101 operating in the backup mode. Specifically, the processing module 102 may re-determine the target mode to be the TOU mode for the power converter 101 that is operating in the backup mode. Then, the processing module 102 may control the power converter 101 to operate in the TOU mode immediately.

In one embodiment, the criteria 2034_3 may correspond to the TOU mode. It may require a State of Charge (SOC) of the battery is higher than a charging threshold. If the criteria 2034_3 is met, the processing module 102 may switch the power converter from the TOU mode to the self-consumption mode. If the criteria 2034_3 is not met, the processing module 102 may maintain the power converter 101 operating in the TOU mode. Specifically, the processing module 102 may re-determine the target mode to be the self-consumption mode for the power converter 101 that is operating in the TOU mode. Then, the processing module 102 may control the power converter 101 to operate in the self-consumption mode immediately.

The aforementioned charging threshold may be set based on several factors, including battery type, system requirements, and energy management strategies. Typically, manufacturers provide recommended SOC ranges to maximize battery lifespan. For example, lithium-ion batteries often have a charging threshold of 80-90% to prevent overcharging and extend battery life, while lead-acid batteries may be fully charged to 100% for optimal performance, but the present disclosure is not limited thereto.

Notably, checking whether the predicted data matches the recorded data helps evaluate the accuracy of the forecast model. This prevents the system from relying on an inaccurate model to determine the target mode. As a result, a more appropriate target mode can be selected, enhancing overall power usage efficiency.

In one embodiment, the processing module 102 may further perform step 200 before step 202 in FIG. 2. In step 200, the processing module 102 may check whether a criterion corresponding to the operation mode where the power converter is currently operating is met. The criterion involves at least two of the tariff of the power grid, a State of Charge (SOC) of the battery, and the power generation of the PV array. Then, the processing module 102 may maintain the operation mode where the power converter is currently operating if the corresponding criterion is met.

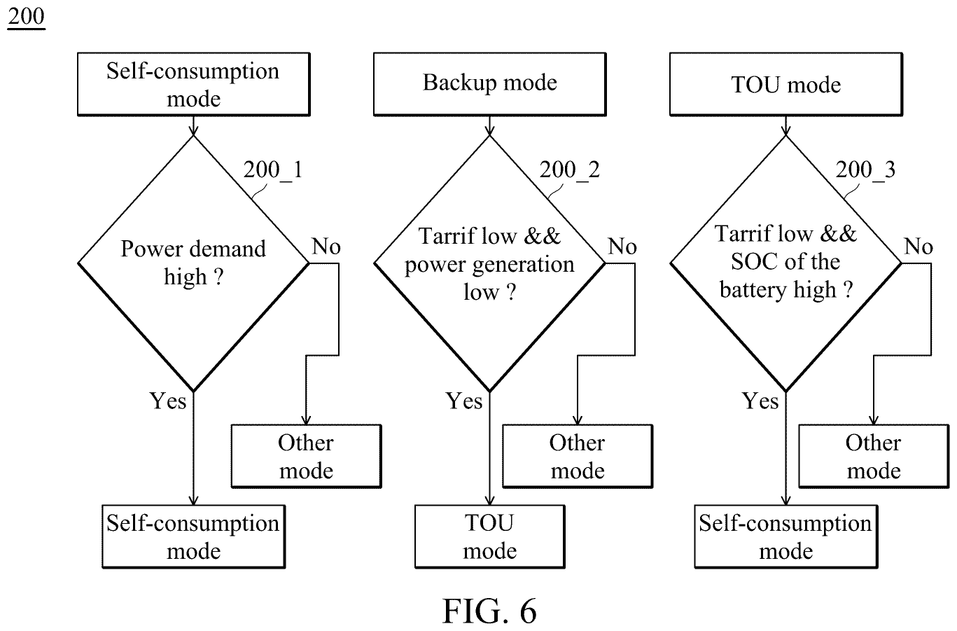

FIG. 6 is a schematic diagram illustrating step 200, according to an embodiment of the present disclosure. As shown in FIG. 6, step 200 may further involve the use of criteria 200_1-200_3.

In one embodiment, the criterion 200_1 may correspond to the self-consumption mode, and may require the tariff and the SOC of the battery to be high. The criterion 200_2 may correspond to the TOU mode, and may require the tariff and the power generation of the PV array to be low. The criterion 200_3 may correspond to the backup mode, and may require the tariff to be low and the SOC of the battery to be high.

Specifically, the criterion 200_1 may require the tariff to be over a maximum tariff threshold and the SOC of the battery to be over the maximum battery threshold, the criterion 200_2 may require the tariff to be below a minimum tariff threshold and the power generation of the PV array to be below a minimum PV threshold; and the criterion 200_3 may require the tariff to be below the minimum tariff threshold and the SOC of the battery to be over the maximum battery threshold.

The aforementioned maximum tariff threshold, maximum battery threshold, minimum tariff threshold and minimum PV threshold may be set based on relevant historical data using machine learning models or statistical methods. For example, the maximum and minimum tariff threshold can be set based on past electricity price fluctuations. For another example, the maximum and minimum tariff threshold can be set based on historical energy usage patterns. For yet another example, the minimum tariff threshold can be set based on historical solar generation patterns.

In one embodiment, if the corresponding criterion is not met, the processing module 102 may switch the power converter 101 to other mode randomly. For example, the processing module 102 may switch the power converter 101 that is operating in the TOU mode to backup mode. For another example, the processing module 102 may switch the power converter 101 that is operating in the self-consumption mode to TOU mode, but the present disclosure is not limited thereto.

In one embodiment, the predicted data and the recorded are represented in a chart. In one embodiment, the processing module 102 updates the chart if the predicted data changes, and waits for 30 minutes if the predicted data does not change.

In one embodiment, once the chart is updated, the processing module 102 checks the aforementioned criterion and then proceeds to step 201. Notably, with the aforementioned criterion, switch time determination, and reduced chart updates, the system can avoid switching between different operation modes too frequently.

The power management system provided herein automatically determines an operation mode for the power converter to regulate power flow among the PV array, the power grid, and the battery. More specifically, by applying AI technology, the power management system can flexibly and accurately switch the power converter between different operation mode in various scenarios based on past, current and future data. This maximizes energy efficiency, reduces costs, and improves reliability.

The above paragraphs are described in various ways. Obviously, the teachings of this article can be implemented in a variety of ways, and any specific architecture or functionality disclosed in the examples is only a representative situation. Based on the teachings of this article, it should be understood in the art that each aspect disclosed in this article can be implemented independently, or two or more aspects can be combined and implemented.

Although the present disclosure has been described using embodiments as above, they are not intended to limit the present disclosure. A person skilled in the art may make some modifications without departing from the spirit and scope of the present disclosure. Therefore, the protection scope of the disclosure shall be determined by the appended patent application scope.

What is claimed is:

1. A power management system for a building, electrically coupled to a photovoltaic (PV) array, a power grid, and a battery, the system comprising:
a power converter, configured to operate in one of operation modes to regulate power flow among the PV array, the power grid, and the battery, wherein the operation modes include a self-consumption mode, a Time of Use (TOU) mode, and a backup mode; and
a processing module, configured to:
generate, through a forecast model, predicted data representing power demand of the building, power generation of the PV array, and tariff of the power grid over a first time period;
determine one of the operation modes to be a target mode for the power converter and a corresponding switch time based on the time series of predicted data; and
control the power converter to operate in the target mode at the switch time.

2. The power management system as claimed in claim 1, wherein the power converter is configured to:
in the self-consumption mode, prioritize using the power generation of the PV array and the battery to supply the power demand of the building;
in the TOU mode, prioritize using the power generation of the PV array and the battery to supply the power demand of the building during peak hours, and prioritize using the power generation of the power grid to supply the power demand of the building during off-peak hours; and
in the backup mode, prioritize using the power generation of the PV array to charge the battery.

3. The power management system as claimed in claim 1, wherein the processing module is further configured to:
in response to the power converter operating in the self-consumption mode, determine the target mode to be the backup mode if the predicted data representing the tariff of the power gird indicates that the tariff will decrease and the predicted data representing the power demand of the building indicates that the power demand will decrease;
in response to the power converter operating in the backup mode, determine the target mode to be the self-consumption mode if the predicted data representing the tariff of the power gird indicates that the tariff will increase, the predicted data representing the power generation of the PV array indicates that the power generation of the PV array will decrease, and the power demand of the building indicates that the power demand will increase; and
in response to the power converter operating in the TOU mode, determine the target mode to be the self-consumption mode if the predicted data representing the tariff of the power gird indicates that the tariff will increase, the predicted data representing the power generation of the PV array indicates that the power generation of the PV array will increase, and the power demand of the building indicates that the power demand will decrease.

4. The power management system as claimed in claim 1, wherein the processing module is further configured to:
record data representing the power demand of the building, the power generation of the PV array, and the tariff of the power grid over a second time period, wherein the second time period is within the first time period and is after the target mode has been determined and before the switch time has been reached;
compare the predicted data within the second time period and the recorded data; and
in response to the predicted data within the second time period matching the recorded data, control the power converter to operate in the target mode at the switch time.

5. The power management system as claimed in claim 4, the processing module is further configured to, in response to the predicted data within the second time period not matching the recorded data:
switch the power converter from the self-consumption mode to the TOU mode if the power demand of the building does not decrease;
switch the power converter from the backup mode to the TOU mode if the power generation of the PV array decreases;
switch the power converter from the TOU mode to the self-consumption mode if a State of Charge (SOC) of the battery is higher than a charging threshold.

6. The power management system as claimed in claim 4, wherein the processing module is further configured to:
in response to the predicted data within the second time period not matching the recorded data, maintain the operation mode where the power converter is currently operating; and
repeat, until the predicted data within the second time period matches the recorded data, the operation of recording the data representing the power demand of the building, the power generation of the PV array, and the tariff of the power grid over the second time period and the operation of comparing the predicted data within the second time period and the recorded data.

7. The power management system as claimed in claim 4, wherein the processing circuitry is further configured to:
generates, through the forecast model based on historical data representing the power demand of the building, the power generation of the PV array, and tariff of the power grid from a past period, the predicted data in a time resolution equal to or smaller than the second time period, wherein the length of the past period is longer than the first time period.

8. The power management system as claimed in claim 4, wherein the processing module is further configured to, before determining the target mode:
check whether the tariff of the power grid, a State of Charge (SOC) of the battery, and the power generation of the PV array meet a criterion corresponding to the operation mode where the power converter is currently operating; and
in response to meeting the corresponding criterion, maintain the operation mode where the power converter is currently operating.

9. The power management system as claimed in claim 8, wherein the criterion comprises:
for the self-consumption mode, requiring the tariff and the SOC of the battery to be over a maximum tariff threshold and a maximum battery threshold respectively;
for the TOU mode, requiring the tariff and the power generation of the PV array to be below a minimum tariff threshold and a minimum PV threshold respectively; and
for the backup mode, requiring the tariff to be below the minimum tariff threshold and the SOC of the battery to be over the maximum battery threshold.

10. The power management system as claimed in claim 1, wherein the forecast model is trained using at least one of a weather dataset, a home appliance dataset, a PV generation dataset, and a power demand dataset.

11. A power management method, executed by a system for a building, wherein the system comprises a power converter and a processing module and is electrically coupled to a photovoltaic (PV) array, a power grid, and a battery, wherein the power management method comprises:
by the power converter, operating in one of operation modes to regulate power flow among the PV array, the power grid, and the battery, wherein the operation modes include a self-consumption mode, a Time of Use (TOU) mode, and a backup mode; and
by the processing module:
generating, through a forecast model, predicted data representing power demand of the building, power generation of the PV array, and tariff of the power grid over a first time period;
determining one of the operation modes to be a target mode for the power converter and a corresponding switch time based on the time series of predicted data; and
controlling the power converter to operate in the target mode at the switch time.

12. The power management method as claimed in claim 11, further comprises:
by the power converter:
in the self-consumption mode, prioritizing using the power generation of the PV array and the battery to supply the power demand of the building;
in the TOU mode, prioritizing using the power generation of the PV array and the battery to supply the power demand of the building during peak hours, and prioritize using the power generation of the power grid to supply the power demand of the building during off-peak hours; and
in the backup mode, prioritizing using the power generation of the PV array to charge the battery.

13. The power management method as claimed in claim 11, further comprises:
by the processing module:
in response to the power converter operating in the self-consumption mode, determining the target mode to be the backup mode if the predicted data representing the tariff of the power gird indicates that the tariff will decrease and the predicted data representing the power demand of the building indicates that the power demand will decrease;
in response to the power converter operating in the backup mode, determining the target mode to be the self-consumption mode if the predicted data representing the tariff of the power gird indicates that the tariff will increase, the predicted data representing the power generation of the PV array indicates that the power generation of the PV array will decrease, and the power demand of the building indicates that the power demand will increase; and
in response to the power converter operating in the TOU mode, determining the target mode to be the self-consumption mode if the predicted data representing the tariff of the power gird indicates that the tariff will increase, the predicted data representing the power generation of the PV array indicates that the power generation of the PV array will increase, and the power demand of the building indicates that the power demand will decrease.

14. The power management method as claimed in claim 11, further comprises:
by the processing module:
recording data representing the power demand of the building, the power generation of the PV array, and the tariff of the power grid over a second time period, wherein the second time period is within the first time period and is after the target mode has been determined and before the switch time has been reached;
comparing the predicted data within the second time period and the recorded data; and
in response to the predicted data within the second time period matching the recorded data, controlling the power converter to operate in the target mode at the switch time.

15. The power management method as claimed in claim 14, further comprises:
by the processing module, in response to the predicted data within the second time period not matching the recorded data:
switching the power converter from the self-consumption mode to the TOU mode if the power demand of the building does not decrease;
switching the power converter from the backup mode to the TOU mode if the power generation of the PV array decreases;
switching the power converter from the TOU mode to the self-consumption mode if a State of Charge (SOC) of the battery is higher than a charging threshold.

16. The power management method as claimed in claim 14, further comprises:
by the processing module:
in response to the predicted data within the second time period not matching the recorded data, maintaining the operation mode where the power converter is currently operating; and
repeating, until the predicted data within the second time period matches the recorded data, the operation of recording the data representing the power demand of the building, the power generation of the PV array, and the tariff of the power grid over the second time period and the operation of comparing the predicted data within the second time period and the recorded data.

17. The power management method as claimed in claim 14, further comprises:
by the processing module:
generating, through the forecast model based on historical data representing the power demand of the building and the power generation of the PV array from a past period, the predicted data in a time resolution equal to or smaller than the second time period, wherein the length of the past period is longer than the first time period.

18. The power management method as claimed in claim 14, further comprises:
by the processing module, before determining the target mode:
checking whether the tariff of the power grid, a State of Charge (SOC) of the battery, and the power generation of the PV array meet a criterion corresponding to the operation mode where the power converter is currently operating; and
in response to meeting the corresponding criterion, maintaining the operation mode where the power converter is currently operating.

19. The power management method as claimed in claim 18, wherein the criterion comprises:
for the self-consumption mode, requiring the tariff and the SOC of the battery to be over a maximum tariff threshold and a maximum battery threshold respectively;
for the TOU mode, requiring the tariff and the power generation of the PV array to be below a minimum tariff threshold and a minimum PV threshold respectively; and
for the backup mode, requiring the tariff to be below the minimum tariff threshold and the SOC of the battery to be over the maximum battery threshold.

20. The power management method as claimed in claim 11, wherein the forecast model is trained using at least one of a weather dataset, a home appliance dataset, a PV generation dataset, and a power demand dataset.
